(19) United States
(12) Patent Application Publication
(10) Pub. No.: US 2013/0063499 A1
(43) Pub. Date: Mar. 14, 2013

(54) DISPLAY DEVICE, DRIVING METHOD OF DISPLAY DEVICE, AND ELECTRONIC APPARATUS

(71) Applicants: Toshihiko Tanaka, Kanagawa (JP); Tsutomu Harada, Kanagawa (JP); Ryoichi Tsuzaki, Kanagawa (JP); Naoyuki Takasaki, Kanagawa (JP)

(72) Inventors: Toshihiko Tanaka, Kanagawa (JP); Tsutomu Harada, Kanagawa (JP); Ryoichi Tsuzaki, Kanagawa (JP); Naoyuki Takasaki, Kanagawa (JP)

(73) Assignee: Japan Display West Inc., Aichi-Ken (JP)

(21) Appl. No.: 13/604,141

(22) Filed: Sep. 5, 2012

(30) Foreign Application Priority Data
Sep. 9, 2011 (JP) 2011-196903

(51) Int. Cl. G09G 5/10

(52) U.S. Cl. 345/690

(57) ABSTRACT

A display device having a memory function within pixels, includes: a drive unit that divides image generation for one frame into plural sub-frames and performs display drive by time-division drive in units of sub-frames, wherein the drive unit performs drive of bringing centers of pixels of gray scale representation into coincidence with centers of display images among the plural sub-frames.

### FIELD

The present disclosure relates to a display device, a driving method of the display device, and an electronic apparatus.

### BACKGROUND

In a display device having a memory function within pixels, the circuit size contained in the pixel is limited due to resolution constraints, and the number of display gray scale levels is reduced. Accordingly, a technique called dithering (dither method) of increasing the apparent number of gray scale levels at the expense of resolution is used (for example, see Patent Document 1 (JP-A-2010-38968)).

### SUMMARY

However, the number of gray scale levels is insufficient even using the technique called dithering and the display image is rough, and there are limitations to improvement in display characteristics. Therefore, in order to further improve the display characteristics, it is desired to further increase the number of display gray scale levels.

It is therefore desirable to provide a display device in which the number of display gray scale levels can be further increased, a driving method of the display device, and an electronic apparatus having the display device.

An embodiment of the present disclosure employs a configuration in which a display device has a memory function within pixels, and divides image generation for one frame into plural sub-frames and performs display by time-division drive in units of sub-frames, and brings centers of pixels of gray scale representation into coincidence with centers of display images among the plural sub-frames. This display device is preferable for use in various electronic apparatuses as display units thereof.

In the display device having the above described configuration or an electronic apparatus having the display device, display is performed by time-division drive in units of sub-frames, i.e., FRC (Frame Rate Control) drive, and thereby, the number of display gray scale levels may be increased compared to the case of the drive in units of frames. Here, “FRC drive” is a driving method of displaying halftone brightness of plural gray scale brightness levels by switching different plural gray scale brightness levels at a high speed in units of sub-frames for using persistence of vision (after image effect) of human eyes. Further, by performing drive to bring the centers of pixels of gray scale representation into coincidence with the centers of display images among plural sub-frames, no fluctuation is produced in the display images.

According to the embodiments of the present disclosure, the number of display gray scale levels maybe further increased and no fluctuation is produced in the display images, and thus, the display characteristics may be further improved.

### BRIEF DESCRIPTION OF THE DRAWINGS

FIG. 1 is a block diagram showing an outline of a system configuration of a display device according to an embodiment of the present disclosure.

FIG. 2 is a timing chart showing time relations of 8-bit data (A) input to a panel, 3-bit data (B) after subtractive color processing in a subtractive color processing unit, and 2-bit data (C) written in MIP pixels in units of sub-frames after conversion processing in an FRC data processing unit.

FIG. 3 is a circuit diagram showing an example of basic pixel circuits of pixels.

FIG. 4 is a block diagram showing an example of a circuit configuration of the MIP pixel.

FIG. 5 is a timing chart for explanation of an operation of the MIP pixel.

FIG. 6 is a circuit diagram showing an example of a specific circuit configuration of the MIP pixel.

FIGS. 7A to 7C are explanatory diagrams of pixel division in area coverage modulation.

FIG. 8 is a circuit diagram showing a correspondence relation between three sub-pixel electrodes and two pairs of driver circuits in a three-split pixel structure.

FIG. 9 schematically shows a relation among a full-screen display period of one frame, a sub-frame period of partial display, the number of sub-frames of FRC drive, and a limit period of flicker in human vision.

FIGS. 10A and 10B are explanatory diagrams of the case of 2-bit area coverage modulation and the case of 2-bit area coverage modulation and one-bit FRC drive.

FIG. 11 is a diagram for explanation of combination patterns of sub-pixels in lighted states according to working example 1.

FIG. 12 is a diagram for explanation of combination patterns of sub-pixels in lighted states according to working example 2.

FIG. 13 is a diagram for explanation of combination patterns of sub-pixels in lighted states according to working example 3.

FIG. 14 is a diagram for explanation of combination patterns of sub-pixels in lighted states according to working example 4.

FIG. 15 shows a relation among a full-screen display period of one frame, the number of display gray scale levels within a unit sub-frame, a sub-frame period of partial display, and the number of all display gray scale levels.

FIGS. 16A to 16F show specific examples of weighting with respect to sub-frame periods.

FIG. 17 is a list showing the numbers of display gray scale levels in the specific examples with respect to sub-frame periods shown in FIGS. 16A to 16F.

### DETAILED DESCRIPTION

As below, an embodiment for implementing the technology of the present disclosure (hereinafter, referred to as “embodiment”) will be explained in detail using the drawings. The present disclosure is not limited to the embodiment, and various numeric values in the embodiment are exemplifications. In the following explanation, the same signs are used for the same elements or the elements having the same functions, and overlapping explanation will be omitted. The explanation will be made in the following order.

1. Overall Explanation on Display Device and Driving Method of Display Device of Embodiment of the Present Disclosure

2. Display Device and Driving Method of Display Device according to Embodiment

2-1. System Configuration

2-2. Pixel Circuit

2-3. MIP System

2-4. Area Coverage Modulation

2-5. Characteristic Parts of Embodiment

3. Electronic apparatus

4. Configuration of Embodiment of the Present Disclosure

### <1. Overall Explanation on Display Device and Driving Method of Display Device of Embodiment of the Present Disclosure>

A display device of an embodiment of the present disclosure is a display device having a memory function within pixels. As this type of display device, for example, a display device of the so-called MIP (Memory In Pixel) system having a memory unit that can store data within the pixels may be exemplified.

As the display device, a known display device such as a liquid crystal display device, an electroluminescence display device, or a plasma display device may be used. In the case of the liquid crystal display device, using memory liquid crystal for pixels, a display device having a memory function within pixels may be obtained. The display device may be a display device compliant with monochrome display or a display device compliant with color display.

The display device having a memory function in pixels may realize display in an analog display mode and display in a memory display mode by a mode change-over switch because the device may store data in the pixels. Here, “analog display mode” is a display mode of analog display of the gray scale levels of pixels. Further, “memory display mode” is a display mode of digital display of the gray scale levels of pixels based on binary information (logical “1”/logical “0”) stored in the pixels.

In the display device having the memory function in pixels, for example, in an MIP display device, there is a tendency that the circuit size contained in the pixel is limited due to resolution constraints, and the number of display gray scale levels is reduced. Accordingly, in the MIP display device, a known technique such as an error diffusion method or a dither method is used for subtractive color processing in order to increase the apparent number of gray scale levels at the expense of resolution.

Further, in order to further increase the number of display gray scale levels, image generation for one frame is divided into plural sub-frames and display drive by time-division drive in units of sub-frames, i.e., FRC drive is performed. As described above, “FRC drive” is a driving method of displaying halftone brightness of plural gray scale brightness levels by switching different plural gray scale brightness levels at a high speed in units of sub-frames for using persistence of vision (after image effect) of human eyes.

By performing the time-division drive in units of sub-frames, i.e., the FRC drive, the number of display gray scale levels may be increased compared to the case of drive in units of frames. Further, in the FRC-drive display device, drive to bring the centers of pixels of gray scale representation into coincidence with the centers of display images among plural sub-frames is performed.

Here, “coincidence” includes not only the strict coincidence of the centers of pixels of gray scale representation with the centers of display images among plural sub-frames but also substantial coincidence. Various fluctuations produced in design or manufacturing may be allowed. Further, “coincidence” includes the case where the centers of pixels of gray scale representation substantially coincide with the centers of display images among plural sub-frames by time integration among the plural sub-frames.

In this manner, in the FRC-drive display device, by performing drive to bring the centers of pixels of gray scale representation into coincidence with the centers of display images among plural sub-frames, no fluctuation is produced in the display images and display characteristics may be further improved.

The MIP display device can represent two gray scale levels for one bit with respect to each pixel. Accordingly, for driving of pixels, area coverage modulation is preferably used as gray scale representation. Here, “area coverage modulation” is a gray scale representation method of representing 2^{N} gray scale levels by N sub-pixel electrodes with weighted area ratios by 2⁰, 2¹, 2², . . . , 2^{N-1}. The area coverage modulation is employed for the purpose of improving non-uniformity of image quality due to characteristics variations of TFTs (Thin Film Transistors) forming the pixel circuits, for example.

<2. Display Device and Driving Method of Display Device according to Embodiment>

### [2-1. System Configuration]

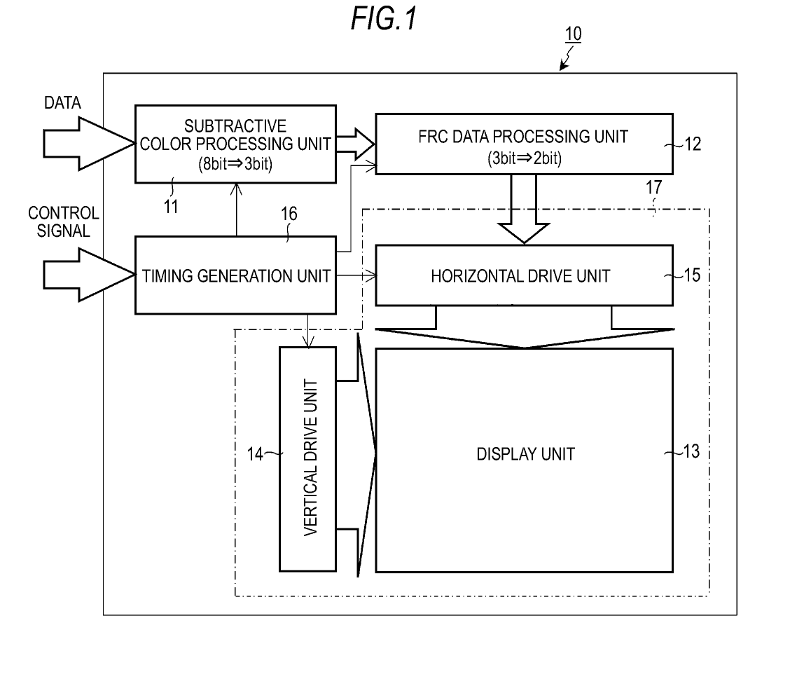

FIG. 1 is a block diagram showing an outline of a system configuration of a display device according to an embodiment of the present disclosure. The display device according to the embodiment employs a configuration of performing display by time-division drive in units of sub-frames, i.e., the FRC drive. Further, the pixels of the display device according to the embodiment are pixels of the MIP system having memory parts with respect to each pixel.

As shown in FIG. 1, the display device 10 according to the embodiment includes a subtractive color processing unit 11, an FRC data processing unit 12, a display unit 13, a vertical drive unit 14, a horizontal drive unit 15, and a timing generation unit 16. Further, of the component elements (11 to 16), the display unit 13, the vertical drive unit 14, and the horizontal drive unit 15 are mounted on a panel (substrate) 17.

To the display device 10, data and control signals are input from a host device (not shown) outside of the panel. The data input to the display device 10 is 8-bit data, for example, for displaying images on the display unit 13, and provided to the subtractive color processing unit 11. The control signals input to the display device 10 are signals containing various control information for entirely controlling the display device 10, and provided to the timing generation unit 16.

When the control signals are input, the timing generation unit 16 provides various timing signals to the subtractive color processing unit 11, the FRC data processing unit 12, the vertical drive unit 14, and the horizontal drive unit 15. That is, the subtractive color processing unit 11, the FRC data processing unit 12, the vertical drive unit 14, and the horizontal drive unit 15 perform various operations under the driving according to the timing signals based on the control signals provided from the timing generation unit 16.

The subtractive color processing unit 11 performs subtractive color processing of converting 8-bit data input from the external host device into 3-bit data, for example, under the driving according to the timing signals provided from the timing generation unit 16. For the subtractive color processing, for example, a known error diffusion method is used. Note that, as a technique of subtractive color processing, not limited to the error diffusion method, but a known dither method or the like may be used.

In the subtractive color processing, by 2-bit error diffusion with respect to an original image, image roughness is noticeable. On the other hand, by 3-bit error diffusion, image roughness may be significantly improved. The 3-bit data subjected to the subtractive color processing in the subtractive color processing unit 11 is provided to the FRC data processing unit 12.

The FRC data processing unit 12 temporarily stores the 3-bit data provided from the subtractive color processing unit 11 and FRC-converts the 3-bit data under the driving by the timing signals provided from the timing generation unit 16. In the FRC conversion, for the FRC drive, processing of converting the 3-bit data subjected to the subtractive color processing into data with the smaller number of bits than that of the data, for example, into 2-bit data in units of sub-frames.

In the display device 10 having the above described configuration according to the embodiment, the FRC data processing unit 12, the vertical drive unit 14, the horizontal drive unit 15, and the timing generation unit 16 form a drive unit of dividing image generation for one frame into plural sub-frames and performing display drive by time-division drive in units of sub-frames.

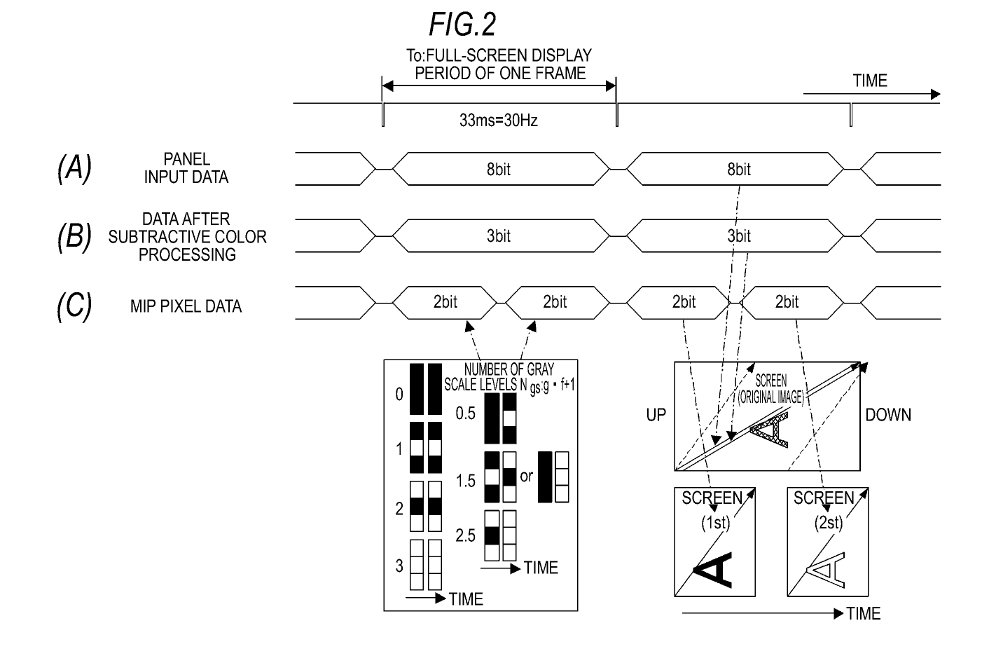

FIG. 2 is a timing chart showing time relations of 8-bit data (A) input to the panel 17, 3-bit data (B) after subtractive color processing in the subtractive color processing unit 11, and 2-bit data (C) written in MIP pixels in units of sub-frames after conversion processing in the FRC data processing unit 12. In FIG. 2, Tₒ is a full-screen display period of one frame.

FIG. 2 also shows a conceptual diagram of drawing by FRC drive. Here, to facilitate understanding, the case of drawing a character “A” is taken as an example. To the panel 17, halftone 8-bit data of the character “A” is input from the external host device. The 8-bit data is subjected to subtractive color processing into 3-bit data. Then, a darker image is drawn in the first sub-frame and a lighter image is drawn in the second sub-frame, and thereby, the original (original image) halftone gray scale levels may be displayed totally by one frame.

The explanation will be returned to FIG. 1. The display unit 13 has pixels two-dimensionally arranged in a matrix, and scan lines wired with respect to each pixel row and signal lines wired with respect to each pixel column with respect to the matrix arrangement. The specific configuration of the display unit 13 will be described later.

The vertical drive unit 14 selects and scans the respective pixels of the display unit 13 in units of pixel rows. The circuit configuration of the vertical drive unit 14 is not particularly limited. The vertical drive unit 14 maybe formed by a shift register, a logic circuit, etc., or formed using an address decoder.

The horizontal drive unit 15 supplies data provided from the FRC data processing unit 12 to the respective pixels of the pixel row selected by the vertical drive unit 14 through the signal lines. The circuit configuration of the horizontal drive unit 15 is not particularly limited. The horizontal drive unit 15 may supply data to the respective pixels of the pixel row selected by the vertical drive unit 14 simultaneously for one row or subsequently supplies the data in units of pixels, or supplies the data in units of pluralities of pixels.

### [2-2. Pixel Circuit]

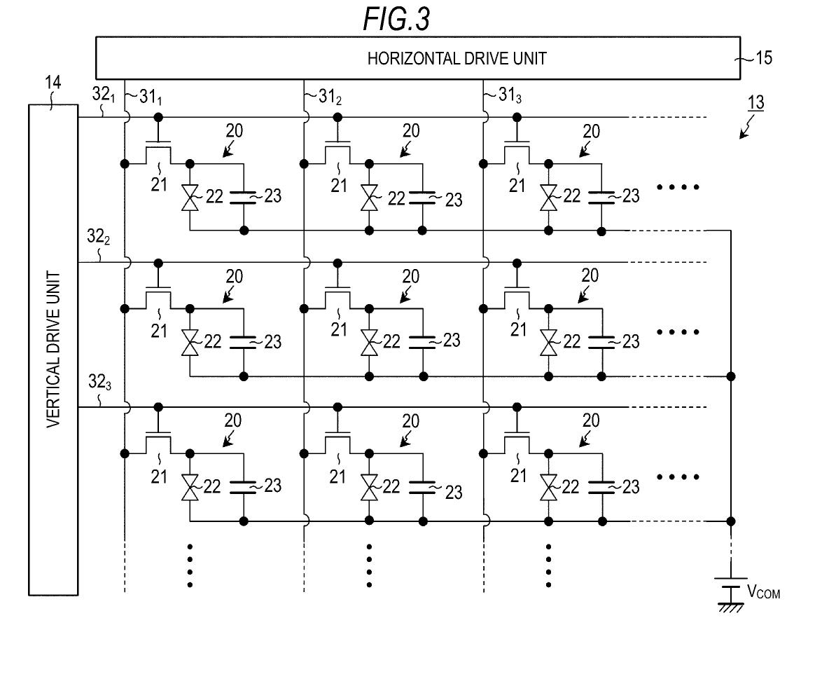

Then, a basic pixel circuit of the pixels forming the display unit 13 will be explained using FIG. 3. Here, the explanation will be made by taking the case where the display device 10 includes a liquid crystal display device as an example.

As shown in FIG. 3, plural signal lines 31 (31₁, −₂, 31₃, . . . ) and plural scan lines 32 (32₁, 32₂, 32₃, . . . ) are provided across one another and pixels 20 are provided in the intersection parts. The respective ends of the signal lines 31 (31₁, 31₂, 31₃, . . . ) are connected to output ends corresponding to the respective columns of the horizontal drive unit 15. The respective ends of the plural scan lines 32 (32₁, 32₂, 32₃, . . . ) are connected to output ends corresponding to the respective rows of the vertical drive unit 14.

The pixels 20 each includes a pixel transistor 21 of a thin-film transistor (TFT), a liquid crystal capacitance 22, and a retention capacitance 23. The pixel transistors 21 have gate electrodes connected to the scan lines 32 (32₁, 32₂, 32₃, . . . ) and one source/drain electrodes connected to the signal lines 31 (31₁, 31₂, 31₃, . . . ).

The liquid crystal capacitance 22 refers to a capacitance component of a liquid crystal material generated between the pixel electrode and the opposite electrode formed to be opposed thereto, and the pixel electrode is connected to the other source/drain electrode of the pixel transistor 21. A common potential V_{COM} of a direct-current voltage is applied to the opposite electrodes of the liquid crystal capacitances 22 of all pixels in common. The retention capacitance 23 has one electrode connected to the pixel electrode of the liquid crystal capacitance 22 and the other electrode connected to the opposite electrode of the liquid crystal capacitance 22, respectively.

As is clear from the above described pixel circuits, the plural signal lines 31 (31₁, 31₂, 31₃, . . . ) are wires that transmit signals for driving the pixels 20, i.e., data output from the horizontal drive unit 15 to the pixels 20 with respect to each pixel column. Further, the plural scan lines 32 (32₁, 32₂, 32₃, . . . ) are wires that transmit signals for selecting the pixels 20 in units of rows, i.e., scan signals output from the vertical drive unit 14 with respect to each pixel row.

### [2-3. MIP System]

In the display device 10 according to the embodiment, a pixel having a memory function, for example, an MIP pixel having a memory part that can store data with respect to each pixel is used as the pixel 20. In the MIP display device, a fixed voltage is constantly applied to the pixel 20, and thus, a problem of shading due to voltage variations overtime caused by leakage of light of the pixel transistor 21 may be solved.

Furthermore, the MIP pixel 20 has a memory part for storing data within the pixel 20, and may realize display in an analog display mode and display in a memory display mode by a mode change-over switch (not shown). Here, “analog display mode” is a display mode of analog display of gray scale levels of the pixels 20. Further, “memory display mode” is a display mode of digital display of gray scale levels of the pixels 20 based on binary information (logical “1”/logical “0”) stored in the memory parts within the pixels 20.

In the case of the memory display mode, information held in the memory parts is used, and, if the writing operation of signal potentials reflecting the gray scale levels is singly executed, execution constantly with the frame period is not necessary. Accordingly, in the case of the memory display mode, compared to the case of the analog display mode requiring execution of the writing operation of the signal potentials reflecting the gray scale levels constantly with the frame period, the necessary power consumption is less, in other words, the lower power consumption of the display device may be realized.

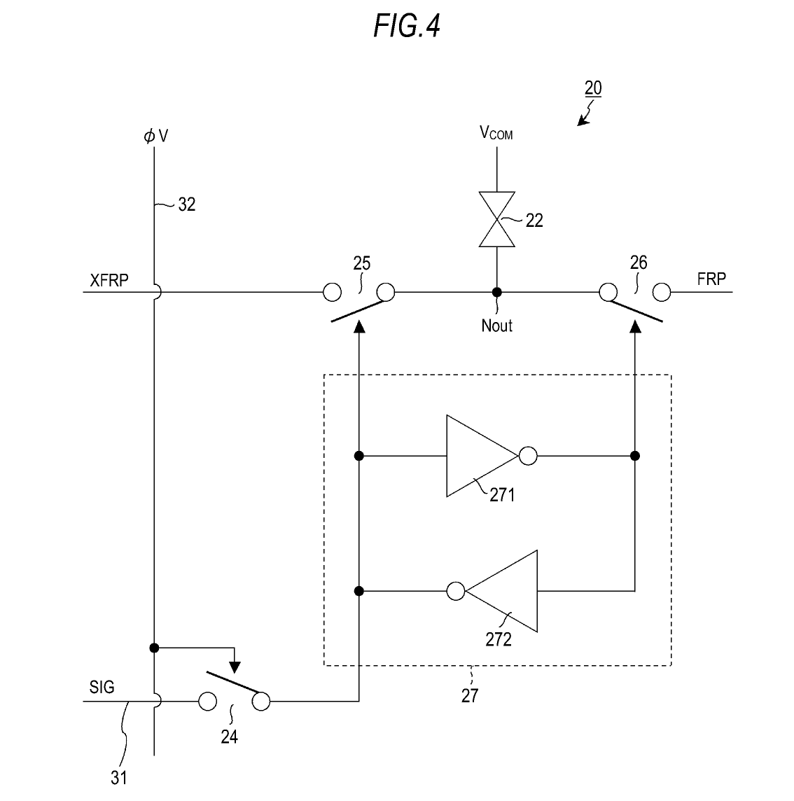

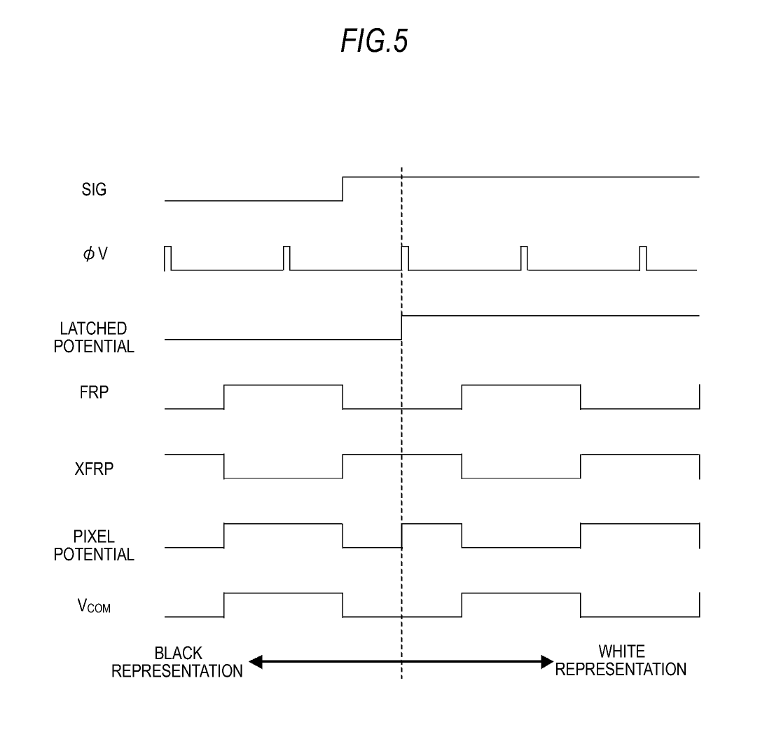

FIG. 4 is a block diagram showing an example of a circuit configuration of the MIP pixel 20. Further, FIG. 5 is a timing chart for explanation of an operation of the MIP pixel 20.

As shown in FIG. 4, the pixel 20 has a pixel configuration with SRAM function having three switch elements 24 to 26 and a latch part 27 in addition to the liquid crystal capacitance (liquid crystal cell) 22.

The switch element 24 has one end connected to the signal line 31 (corresponding to the signal lines 31₁ to 31₃ in FIG. 3). When a scan signal φV is provided from the vertical drive unit 14 in FIG. 3 via the scan line 32, the switch element is turned on (closed) and retrieves data SIG supplied from the horizontal drive unit 15 in FIG. 3 via the signal line 31. The latch part 27 includes inverters 271, 272 parallel-connected oppositely to each other, and holds (latches) a potential in response to the data SIG retrieved by the switch element 24.

A voltage FRP at the same phase with that of the common voltage V_{COM} and a voltage XFRP at the opposite phase are provided to the respective one terminals of the switch elements 25, 26. The respective other terminals of the switch elements 25, 26 are connected in common and serves as an output node Nₒᵤₜ of the pixel circuit. One of the switch elements 25, 26 is turned on in response to the polarity of the latched potential of the latch part 27. Thereby, with respect to the liquid crystal capacitance 22 with the opposite electrode to which the common voltage V_{COM} is applied, the voltage FRP at the same phase or the voltage XFRP at the opposite phase is applied to the pixel electrode.

As is clearly from FIG. 5, in the case of a liquid crystal panel of normally black (black representation with no voltage application), when the latched potential of the latch part 27 has negative polarity, the pixel potential of the liquid crystal capacitance 22 is at the same phase with that of the common voltage V_{COM} and provides black representation and, when the latched potential of the latch part 27 has positive polarity, the pixel potential of the liquid crystal capacitance 22 is at the opposite phase to that of the common voltage V_{COM} and provides white representation.

As is clear from the above description, in the MIP pixel 20, one of the switch elements 25, 26 is turned on in response to the polarity of the latched potential of the latch part 27, and thus, the voltage FRP at the same phase or the voltage XFRP at the opposite phase is applied to the pixel electrode of the liquid crystal capacitance 22. Thereby, there is no concern about shading because a fixed voltage is constantly applied to the pixel 20.

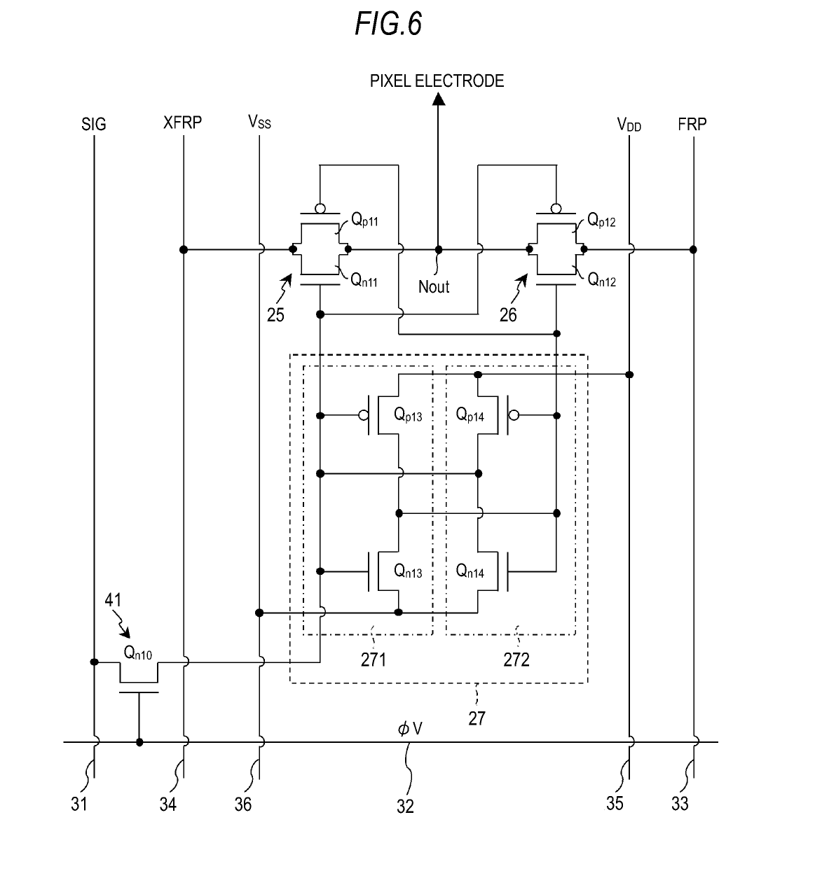

FIG. 6 is a circuit diagram showing an example of a specific circuit configuration of the pixel 20, and, in the drawing, the parts corresponding to those in FIG. 4 are shown by the same signs.

In FIG. 6, the switch element 24 includes an Nch MOS transistor Qₙ₁₀, for example. The Nch MOS transistor Qₙ₁₀ has one source/drain electrode connected to the signal line 31 and a gate electrode connected to the scan line 32.

Both of the switch elements 25, 26 include transfer switches in which Nch MOS transistors and Pch MOS transistors are parallel-connected. Specifically, the switch element 25 has a configuration in which an Nch MOS transistor Qₙ₁₁ and a Pch MOS transistor Qₚ₁₁ are parallel-connected to each other. The switch element 26 has a configuration in which an Nch MOS transistor Qₙ₁₂ and a Pch MOS transistor Qₚ₁₂ are parallel-connected to each other.

The switch elements 25, 26 are not necessarily the transfer switches in which Nch MOS transistors and Pch MOS transistors are parallel-connected. The switch elements 25, 26 maybe formed using single conducting MOS transistors, i.e., Nch MOS transistors and Pch MOS transistors. The common connection node of the switch elements 25, 26 serves as the output node Nₒᵤₜ of the pixel circuit.

Both of the inverters 271, 272 include CMOS inverters, for example. Specifically, the inverter 271 has gate electrodes and drain electrodes of an Nch MOS transistor Qₙ₁₃ and Pch MOS transistor Qₚ₁₃ connected in common. The inverter 272 has gate electrodes and drain electrodes of an Nch MOS transistor Qₙ₁₄ and a Pch MOS transistor Qₚ₁₄ connected in common.

The pixels 20 basically having the above described circuit configuration are developed in the horizontal direction and the vertical direction and arranged in a matrix. For the matrix arrangement of the pixels 20, in addition to the signal lines 31 with respect to each pixel column and the scan lines 32 with respect to each pixel row, wires 33, 34 for transmitting the voltage FRP at the same phase and the voltage XFRP at the opposite phase and power supply lines 35, 36 of a positive-side power supply voltage V_{DD} and a negative-side power supply voltage V_{SS} are wired with respect to each pixel column.

As described above, the display device according to the embodiment (i.e., an active matrix liquid crystal display device) 10 has a configuration in which the pixels (MIP) 20 with SRAM function having the latch parts 27 that hold potentials in response to the display data are arranged in the matrix. Note that, in the embodiment, the case of using SRAMs as memory parts contained in the pixels 20 has been taken as an example, however, the SRAMs are just an example, and memory parts having other configurations, for example, DRAMs may be used.

The MIP display device 10 has the memory function (memory part) with respect to each pixel 20, and thus, as described above, the display in the analog display mode and the display in the memory display mode may be realized by the mode change-over switch. Further, in the case of the memory display mode, pixel data held in the memory parts is used for display, thereby, the writing operation of signal potentials reflecting the gray scale levels is singly executed and execution constantly with the frame period is not necessary, and there is an advantage that power consumption of the display device 10 may be reduced.

Further, there is a need to partially rewrite the display screen, i.e., only a part of the display screen. In this case, it is necessary to partially rewrite the pixel data. To partially rewrite the display screen, i.e., partially rewrite pixel data, data transfer is not necessary with respect to the pixels not to be rewritten. Therefore, there is another advantage that the data volume to be transferred is reduced, and further power saving of the display device 10 may be realized.

### [2-4. Area Coverage Modulation]

Incidentally, a display device having a memory function within pixels, for example, an MIP display device can only represent two gray scale levels for one bit with respect to each pixel 20. Accordingly, in the display device 10 according to the embodiment, area coverage modulation is preferably used in employment of the MIP system.

Specifically, the area coverage modulation of dividing a pixel electrode as a display region of the pixel 20 into areally weighted plural pixel (sub-pixel) electrodes is used. As the pixel electrode, a transmission electrode or a reflection electrode may be used. Further, the pixel potentials selected depending on the latched potentials of the latch part 27 are applied to the areally weighted pixel electrodes and gray scale representation is performed by the combination of the weighted areas.

Here, to facilitate understanding, the area coverage modulation of representing four gray scale levels with two bits by weighting the areas (pixel areas) of the pixel electrodes (sub-pixel electrodes) at 2:1 will be explained as an example.

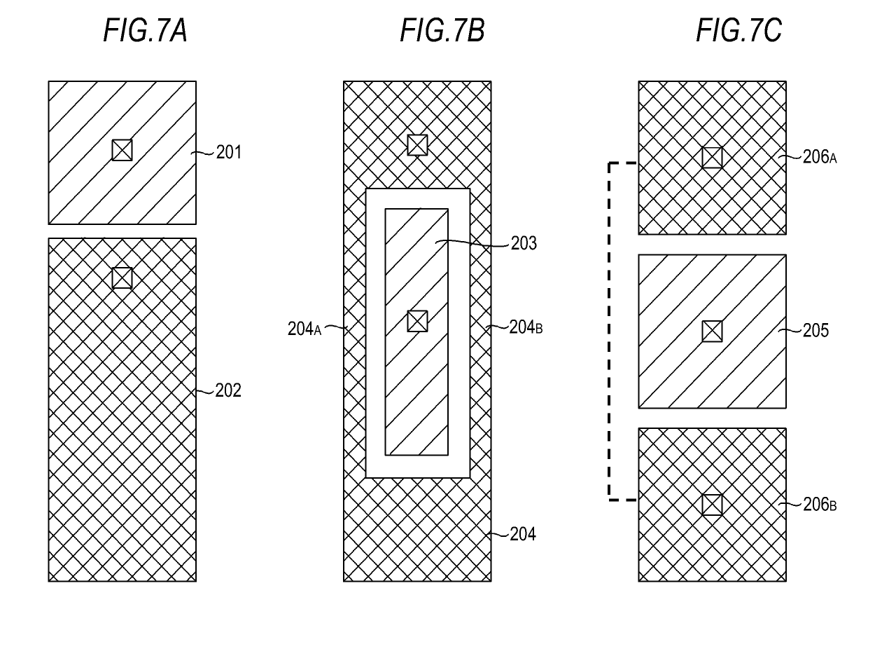

As a structure of weighting the pixel areas at 2:1, as shown in FIG. 7A, there is a typical structure of in which the pixel electrode of the pixel 20 is divided into a sub-pixel electrode 201 of having an area “1” and a sub-pixel electrode 202 having an area twice the sub-pixel electrode 201 (area “2”). However, in the case of the structure in FIG. 7A, the centers (centers of gravity) of the respective gray scale levels (display image) do not coincide with the center (center of gravity) of one pixel, and the structure is not preferable for gray scale representation.

As a structure of bringing the centers of the respective gray scale levels into coincidence with the center of one pixel, as shown in FIG. 7B, there is a conceivable structure in which the center part of a sub-pixel electrode 204 having area “2” is hollowed out in a rectangular shape, for example, a sub-pixel electrode 203 having area “1” is provided in the center part of the hollowed out rectangular region. However, in the case of the structure in FIG. 7B, widths of connection parts 204A, 204B of the sub-pixel electrode 204 located at both sides of the sub-pixel electrode 203 are smaller, and the reflection area of the entire sub-pixel electrode 204 becomes smaller and liquid crystal alignment around the connection parts 204A, 204B is difficult.

As described above, in the area coverage modulation, to create the VA (Vertical Aligned) mode in which the liquid crystal molecules are nearly perpendicular to the substrate with no electric field, it is difficult to align liquid crystal in good condition because the application of the voltages to the liquid crystal molecules vary depending on the electrode shapes and electrode sizes. Further, the gray scale design is difficult because the area ratio of the sub-pixel electrodes is not necessarily the reflectance ratio. The reflectance is determined depending on the areas of the sub-pixel electrodes and the liquid crystal alignment. In the case of the structure in FIG. 7A, even when the area ratio is 1:2, the ratio of the lengths around the electrodes is not 1:2. Therefore, the area ratio of the sub-pixel electrodes is not necessarily the reflectance ratio.

From the point of view, in employment of area coverage modulation, for consideration of gray scale representation and effective utilization of the reflection area, as shown in FIG. 7C, a configuration in which the pixel electrode is divided into three sub-pixel electrodes 205, 206A, 206B having equal areas (sizes), for example, the so-called three-split electrode configuration is desirable.

In the case of the three-split electrode configuration, the upper and lower two sub-pixel electrodes 206A, 206B sandwiching the center sub-pixel electrode 205 are paired, the paired two sub-pixel electrodes 206A, 206B are simultaneously driven, and thereby, the pixel areas are weighted at 2:1 between the center sub-pixel electrode 205 and themselves. Further, the centers (centers of gravity) of the respective gray scale levels (display image) may coincide with the center (center of gravity) of one pixel.

However, for electrical contact with the driver circuit with respect to each of the three sub-pixel electrodes 205, 206A, 206B, the number of contacts of metal wires is increased compared to the structures in FIGS. 7A and 7B, and the pixel size becomes larger, which causes to inhibit the higher definition. Especially, in the case of the MIP pixel configuration having the memory part with respect to each pixel 20, as is clear from FIG. 6, many circuit configuration elements such as transistors and contact parts exist within one pixel 20 and the layout areas are not enough, and thus, one contact part largely affects the pixel size.

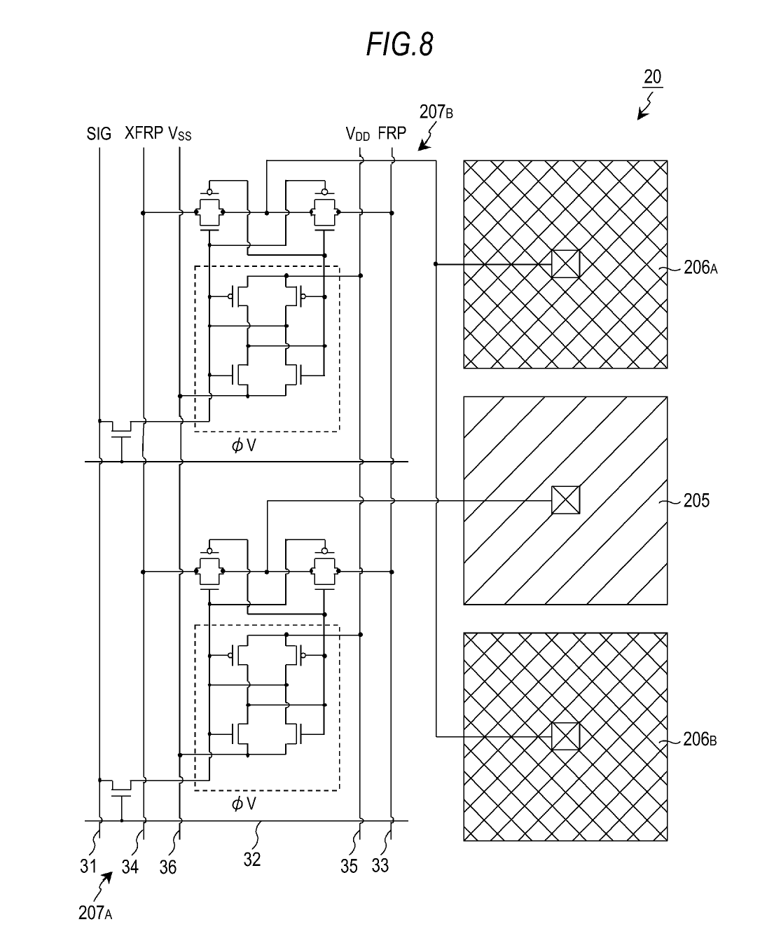

To reduce the number of contacts, a pixel structure in which two sub-pixel electrodes 206A, 206B separating from each other with one sub-pixel electrode 205 in between are electrically coupled (connected) may be used. Then, as shown in FIG. 8, one sub-pixel electrode 205 is driven by one driver circuit 207A, and the other two sub-pixel electrodes 206A, 206B are simultaneously driven by the other one driver circuit 207B. Here, the driver circuits 207A, 207B correspond to the pixel circuit shown in FIG. 6.

As described above, by driving the two sub-pixel electrodes 206A, 206B using one driver circuit 207A, the circuit configuration of the pixel 20 may be simplified compared to the case where the configuration of driving the two sub-pixel electrodes 206A, 206B using separate driver circuits is employed.

Note that, here, as the pixels having the memory function, the MIP pixels having the memory parts that can store data with respect to each pixel have been used, however, this is just an example. As the pixels having the memory function, not only the MIP pixels but also, for example, pixels using known memory liquid crystal may be exemplified.

### [2-5. Characteristic Parts of Embodiment]

As explained above, the display device 10 according to the embodiment having MIP pixels 20 having the memory function inside performs display by time-division drive in units of sub-frames, i.e., the FRC drive, and thereby, the number of display gray scale levels may be increased compared to the case of drive in units of frames. The display device 10 according to the embodiment further employs the area coverage modulation.

Further, the display device 10 according to the embodiment employing area coverage modulation under the FRC drive performs drive to bring the center of the pixel of gray scale representation into coincidence with the centers of the display images among plural sub-frames. Here, “coincidence of the center of the pixel of gray scale representation with the centers of the display images among plural sub-frames” refers to coincidence of the center of one pixel with the centers of the respective gray scale levels among plural sub-frames.

Furthermore, to bring the center of one pixel into coincidence with the centers of the gray scale levels among plural sub-frames, in each of the plural sub-frames, the combinations of sub-pixels to be turned on of the plural sub-pixels may be set with respect to each gray scale level. In this manner, by performing drive to bring the center of the pixel of gray scale representation into coincidence with the centers of the display images among plural sub-frames, no fluctuation is produced in the display images, and thus, the display characteristics may be further improved.

Here, given that the number of the minimum unit areas (i.e., the number of sub-pixel electrodes) per unit pixel is g (natural number), the number of sub-frames is f (natural number equal to or more than two), and the number of lighted sub-pixels is n (=0 to g·f), the number of combinations of gray scale levels in area coverage modulation, i.e., the number of all display gray scale levels N_{gs} is generally N_{gs}=gfCn.

However, there is a restriction that the number of pixels lighted at the same time within the sub-frame should be connected. Specifically, as described above, the case of the pixel structure in which the two sub-pixel electrodes 206A, 206B are connected corresponds to the restriction. Further, it is necessary to bring the center of one pixel into coincidence with the center of gray scale representation. From the view point, the number of display gray scale levels N is actually N_{gs}=number of gray scale unit areas+1=g·f+1. The specific working examples will be described later.

Incidentally, in the case of partial moving image display of partially displaying moving images near the center part of the display screen, the display region is smaller, and, in normal display of display in units of frames (frame period), a period in which display update is stopped is generated. By performing the FRC drive of updating images at a higher speed with the drawing speed as it is by advantageously using the time, the number of display bits may be increased. The FRC drive is realized by a drive unit of dividing image generation for one frame into plural sub-frames and performing display drive by time-division drive in unites of sub-frames, i.e., the FRC data processing unit 12, the vertical drive unit 14, the horizontal drive unit 15, and the timing generation unit 16.

As described above, the FRC drive utilizes persistence of vision of eyes. Therefore, it is important to perform FRC drive in a frame period lower than the limit period of flicker in human vision (1/50 Hz for PAL drive, 1/60 Hz for NTSC drive).

Generally, drive should be performed under the condition that the following relations are satisfied among a full-screen display period of one frame Tₒ, a sub-frame period of partial display T_{sf}, the number of sub-frames of FRC drive N_{frc}, and the limit period of flicker in human vision. The relations are such that the full-screen display period of one frame Tₒ is smaller than the limit period of flicker in human vision, and a total sub-frame period (=T_{sf}×N_{frc}) determined by the sub-frame period of partial display T_{sf} and the number of sub-frames of FRC drive N_{frc} is smaller than the full-screen display period of one frame Tₒ.

As an example, in the case of the PAL drive, the screen is formed in a shorter period than the period of 1/50 Hz. Further, the drive under the condition that the above described relations are satisfied means that the sub-frame is formed in the shorter time than the time of the full-screen display period of the formed one screen (one frame).

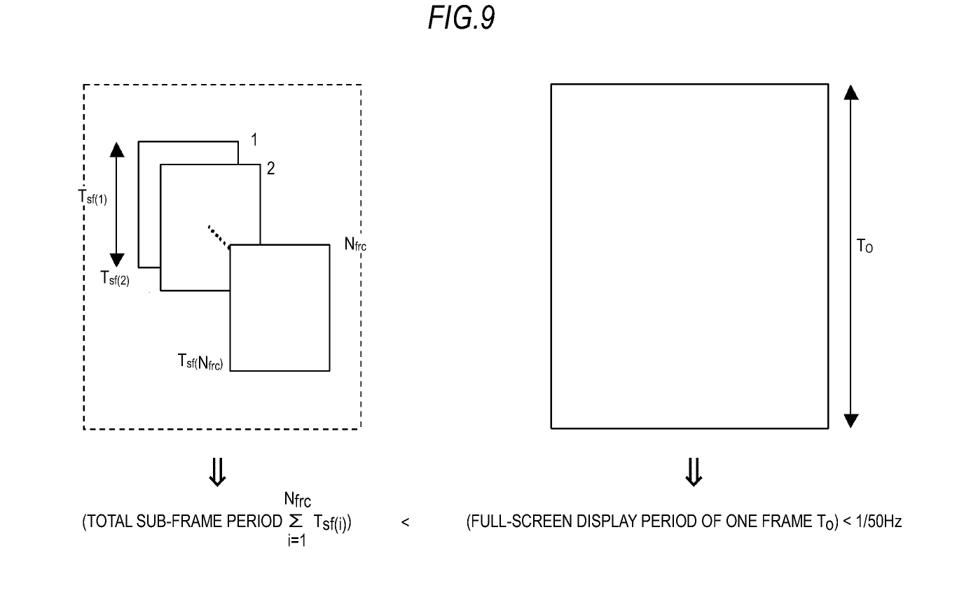

FIG. 9 schematically shows the relation of the full-screen display period of one frame Tₒ, the sub-frame period of partial display T_{sf}, the number of sub-frames of FRC drive N_{frc}, and the limit period of flicker in human vision (for example, 1/50 Hz in consideration of the PAL drive). By performing the FRC drive under the condition, the number of display gray scale levels for FRC drive bits is increased.

Here, as a specific example, in the pixel structure in which the pixel 20 has the three-split electrode configuration and the upper and lower two sub-pixel electrodes 206A, 206B sandwiching the center sub-pixel electrode 205 are simultaneously driven, the case of performing 1-bit FRC drive for partial display of 2-bit display will be explained. In this case, g=3, f=2, and N_{gs}=3×2+1=7, and thus seven gray scale level representation is obtained.

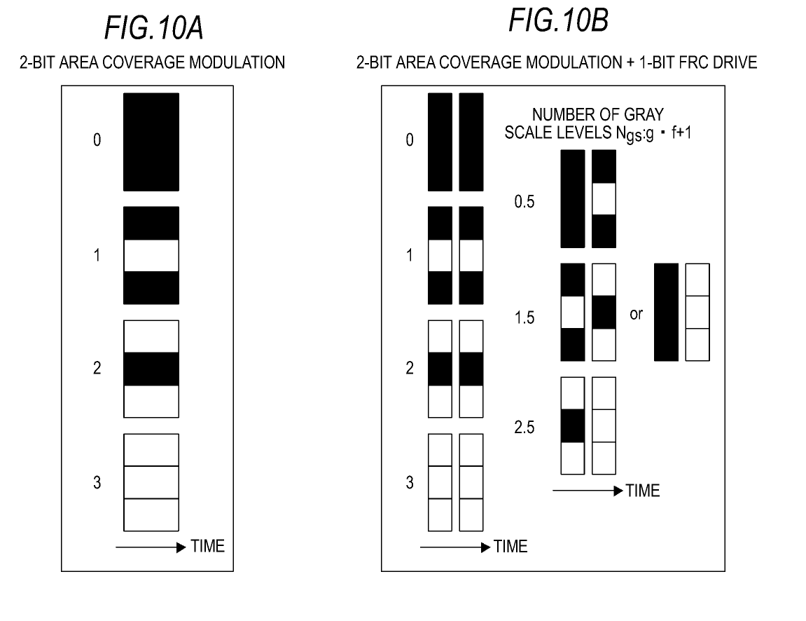

In the case of only the 2-bit area coverage modulation, one screen is formed with one frame period. As shown in FIG. 10A, a total of four gray scale level representation of “0” such that all of the three sub-pixels are turned off, “1” such that only the center sub-pixel is turned on, “2” such that the upper and lower two sub-pixels are turned on, and “3” such that all of the three sub-pixels are turned on.

On the other hand, in the case of the 2-bit area coverage modulation and 1-bit FRC drive, one screen is formed with two sub-frame periods. Further, to the four gray scale levels of the same lighting drive in the first and the second sub-frames, three gray scale levels of 0.5, 1.5, 2.5 as shown in FIG. 10B are added. At the gray scale level of 0.5, all of the three sub-pixels are turned off in the first sub-frame and only the center sub-pixel is turned on in the second sub-frame.

At the gray scale level of 1.5, only the center sub-pixel is turned on in the first sub-frame and the upper and lower two sub-pixels are turned on in the second sub-frame. Or, all of the three sub-pixels are turned off in the first sub-frame and all of the three sub-pixels are turned on in the second sub-frame. At the gray scale level of 2.5, the upper and lower two sub-pixels are turned on in the first sub-frame and all of the three sub-pixels are turned on in the second sub-frame.

As is clear from the above description, by performing the FRC drive as the driving method of displaying halftone brightness of plural gray scale brightness levels, the number of display gray scale levels N_{gs} maybe increased by the amount of bits of FRC drive. Incidentally, in the case of the simple pixel configuration of three bits, the circuit therefore is packed within the pixel (sub-pixel) 20, and thus, the size of the pixel 20 becomes larger unless the higher-definition wiring rule is realized and disadvantageous in higher definition of the display device.

Further, according to the area coverage modulation in the pixel structure in which the pixel 20 has the three-split electrode configuration and the upper and lower two sub-pixel electrodes 206A, 206B sandwiching the center sub-pixel electrode 205 are simultaneously driven, the centers of pixels of gray scale representation may be brought into coincidence with the centers of display images (gray scale levels) among plural sub-frames. Further, the centers of pixels of gray scale representation coincide with the centers of gray scale levels (display images) among plural sub-frames, and no fluctuation is produced in the sub-frame period in the display images and display characteristics may be further improved. Furthermore, no fluctuations is produced in the sub-frame period in the display images, and thus, the time of the sub-frame period (frame rate) maybe made slower and the power consumption under the FRC drive may be reduced.

Here, in order to bring the centers of pixels of gray scale representation into coincidence with the centers of display images among plural sub-frames, the upper and lower two sub-pixel electrodes 206A, 206B sandwiching the center sub-pixel electrode 205 are connected to each other, however, this is just an example. Specifically, it is not necessary to connect the upper and lower sub-pixel electrodes 206A, 206B to each other as long as the sub-pixel electrodes 206A, 206B may be simultaneously driven.

Note that, to connect the upper and lower two sub-pixel electrodes 206A, 206B to each other is to drive the sub-pixel electrodes 206A, 206B by one driver circuit as described above. On the other hand, by driving the sub-pixel electrodes 206A, 206B using separate driver circuits and the separate driver circuits with the same timing, the sub-pixel electrodes 206A, 206B may be simultaneously driven.

Subsequently, the in area coverage modulation under the FRC drive, for bringing the centers of pixels of gray scale representation into coincidence with the centers of display images among plural sub-frames, specific working examples of combination patterns of the sub-pixels in lighted states in the respective plural sub-frames will be explained. As below, the sub-pixels in the lighted states may be referred to as “lighted sub-pixels”.

In the following working examples 1-4, it is assumed that the pixel 20 has the three-split electrode configuration and the upper and lower two sub-pixel electrodes 206A, 206B sandwiching the center sub-pixel electrode 205 are simultaneously driven by one drive circuit 207A (see FIG. 8).

### Working Example 1

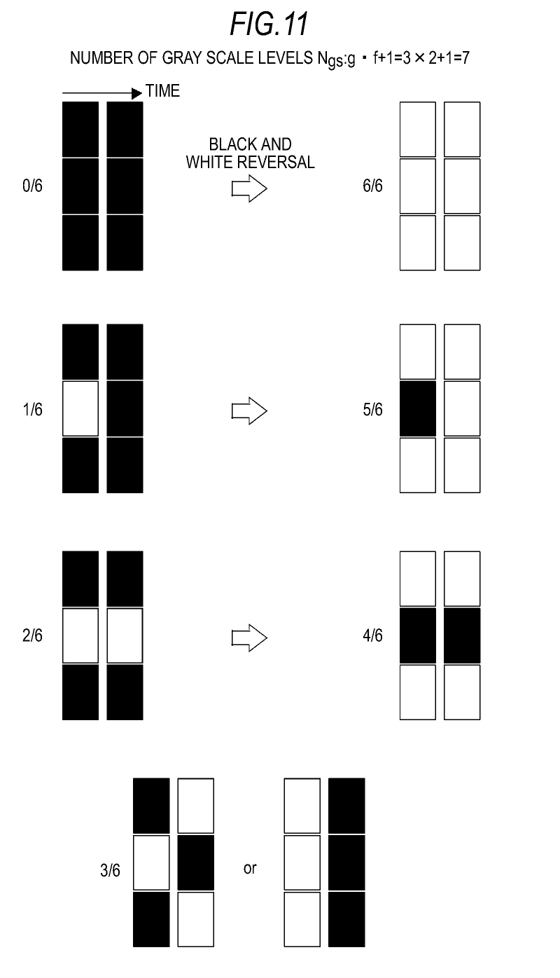

FIG. 11 is a diagram for explanation of combination patterns of sub-pixels in lighted states according to working example 1. In FIG. 11, the sub-pixels shown by white rectangular shapes represent the sub-pixels in on-states, and sub-pixels shown by black rectangular shapes represent the sub-pixels in off-states. The same applies to the other working examples.

Working example 1 is an example of area coverage modulation at the area ratio of 1:2, the number of sub-frames of two, FRC drive at the time ratio of 1:1. Here, the time ratio is a ratio of the respective times of the first sub-frame and the second sub-frame. In this case, g=3, f=2, and the number of display gray scale levels N_{gs} is N_{gs}=3×2+1=7, and double speed or faster display with seven gray scale levels of 0/6 to 6/6 is obtained.

At the gray scale level of 0/6, all of the three sub-pixels are turned off in both the first sub-frame and the second sub-frame. At the gray scale level of 1/6, the center sub-pixel is turned on in the first sub-frame and all of the three sub-pixels are turned off in the second sub-frame. At the gray scale level of 2/6, the center sub-pixel is turned on in both the first sub-frame and the second sub-frame.

At the gray scale level of 3/6, there are two patterns such that the center sub-pixel is turned on in the first sub-frame and the upper and lower two sub-pixels are turned on in the second sub-frame, or all of the three sub-pixels are turned on in the first sub-frame and all of the three sub-pixels are turned off in the second sub-frame. Note that, in the case of the right pattern in the drawing, the brightness difference (gray scale level difference) is larger between the first sub-frame and the second sub-frame, and flicker is likely to occur. Therefore, in the case of the gray scale level of 3/6, the better display condition is obtained in the left pattern in the drawing of the two patterns.

The gray scale levels of 4/6, 5/6, 6/6 have interpolation relations with the gray scale levels of 2/6, 1/6, 0/6, respectively. That is, at the gray scale level of 4/6, the upper and lower two sub-pixels are turned on in both the first sub-frame and the second sub-frame. At the gray scale level of 5/6, the upper and lower two sub-pixels are turned on in the first sub-frame and all of the three sub-pixels are turned on in the second sub-frame. At the gray scale level of 6/6, all of the three sub-pixels are turned on in both the first sub-frame and the second sub-frame.

As described above, in the case of working example 1 of area coverage modulation at the area ratio of 1:2, the number of sub-frames of two, FRC drive at the time ratio of 1:1, double speed display with seven gray scale levels of the gray scale level of 0/6 at which all of the six sub-pixels are turned off to the gray scale level of 6/6 at which all of the six sub-pixels are turned on is obtained.

Further, as in the case of the gray scale level of 3/6, in setting of the combination patterns of the sub-pixels in the lighted states of the sub-frames (hereinafter, may be referred to as “FRC patterns”), by setting the patterns with the smaller brightness differences (gray scale differences) between the sub-frames, occurrence of flicker may be suppressed. Therefore, the better display condition may be obtained.

### Working Example 2

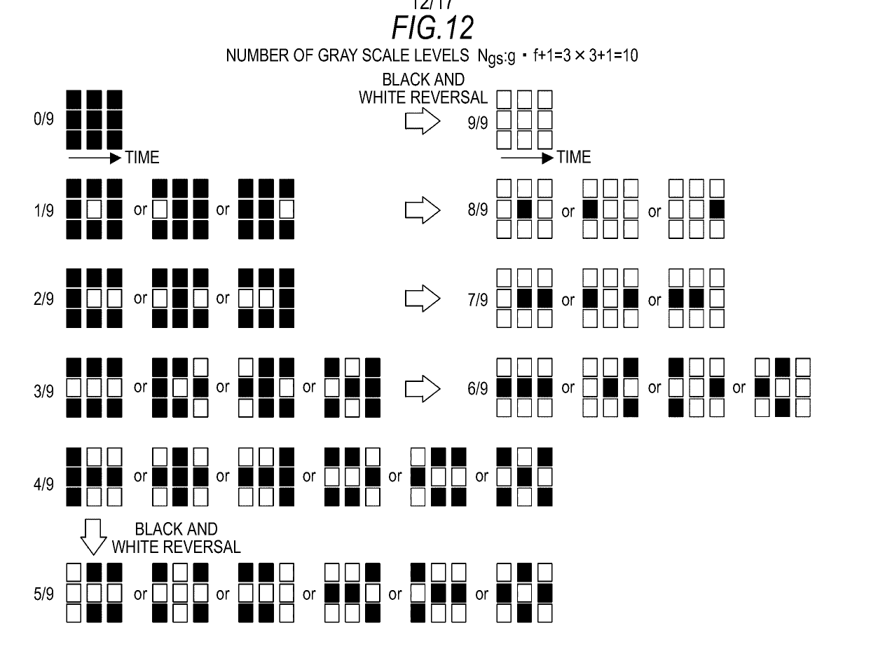

FIG. 12 is a diagram for explanation of combination patterns of sub-pixels in lighted states according to working example 2. Working example 2 is an example of area coverage modulation at the area ratio of 1:2, the number of sub-frames of three, FRC drive at the time ratio of 1:1:1. Here, the time ratio is a ratio of the respective times of the first sub-frame, the second sub-frame, and the third sub-frame. In this case, g=3, f=3, and the number of display gray scale levels N_{gs} is N_{gs}=3×3+1=10, and triple speed or faster display with ten gray scale levels of 0/9 to 9/9 is obtained.

At the gray scale level of 0/9, all of the three sub-pixels are turned off in all of the first sub-frame, the second sub-frame, and the third sub-frame. At the gray scale level of 1/9, three patterns are obtained. In the first pattern, the center sub-pixel is turned on in the second sub-frame and the other eight sub-pixels are turned off. In the second pattern, the center sub-pixel is turned on in the first sub-frame and the other eight sub-pixels are turned off. In the third pattern, the center sub-pixel is turned on in the third sub-frame and the other eight sub-pixels are turned off.

At the gray scale level of 2/9, three patterns are obtained. In the first pattern, the center sub-pixels are turned on in the second and third sub-frames and the other seven sub-pixels are turned off. In the second pattern, the center sub-pixels are turned on in the first and third sub-frames and the other seven sub-pixels are turned off. In the third pattern, the center sub-pixels are turned on in the first and second sub-frames and the other seven sub-pixels are turned off.

At the gray scale level of 3/9, four patterns are obtained. In the first pattern, the center sub-pixel is turned on in all of the first sub-frame, the second sub-frame, and third sub-frame and the other six sub-pixels are turned off. In the second pattern, all of the three sub-pixels are turned off in the first sub-frame, the center sub-pixel is turned on in the second sub-frame, and the upper and lower two sub-pixels are turned on in the third sub-frame.

In the third pattern, the upper and lower two sub-pixels are turned on in the first sub-frame, all of the three sub-pixels are turned off in the second sub-frame, and the center sub-pixel is turned on in the third sub-frame. In the fourth pattern, the center sub-pixel is turned on in the first sub-frame, the upper and lower two sub-pixels are turned on in the second sub-frame, and all of the three sub-pixels are turned off in the third sub-frame.

At the gray scale level of 4/9, six patterns are obtained. In the first pattern, all of the three sub-pixels are turned off in the first sub-frame, the upper and lower two sub-pixels are turned on in the second and third sub-frames. In the second pattern, the upper and lower two sub-pixels are turned on in the first and third sub-frames and all of the three sub-pixels are turned off in the second sub-frame. In the third pattern, the upper and lower two sub-pixels are turned on in the first and second sub-frames and all of the three sub-pixels are turned off in the third sub-frame.

In the fourth pattern, the center sub-pixels are turned on in the first and second sub-frames and the upper and lower two sub-pixels are turned on in the third sub-frame. In the fifth pattern, the upper and lower two sub-pixels are turned on in the first sub-frame and the center sub-pixels are turned on in the second and third sub-frames. In the sixth pattern, the center sub-pixels are turned on in the first and third sub-frames and the upper and lower two sub-pixels are turned on in the second sub-frame.

The gray scale levels of 5/9, 6/9, 7/9, 8/9, 9/9 have interpolation relations with the gray scale levels of 4/9, 3/9, 2/9, 1/9, 0/9, respectively. That is, in the first pattern at the gray scale level of 5/9, all of the three sub-pixels are turned on in the first sub-frame and the center sub-pixels are turned on in the second and third sub-frames. In the second pattern, the center sub-pixels are turned on in the first and third sub-frames and all of the three sub-pixels are turned on in the second sub-frame. In the third pattern, the center sub-pixels are turned on in the first and second sub-frames and all of the three sub-pixels are turned on in the third sub-frame.

In the fourth pattern, the upper and lower two sub-pixels are turned on in the first and second sub-frames and the center sub-pixel is turned on in the third sub-frame. In the fifth pattern, the center sub-pixel is turned on in the first sub-frame and the upper and lower two sub-pixels are turned on in the second and third sub-frames. In the sixth pattern, the upper and lower two sub-pixels are turned on in the first and third sub-frames and the center sub-pixel is turned on in the second sub-frame.

In the first pattern at the gray scale level of 6/9, the upper and lower two sub-pixels are turned on and the center sub-pixel is turned off in all of the first sub-frame, the second sub-frame, and the third sub-frame. In the second pattern, all of the three sub-pixels are turned on in the first sub-frame, the upper and lower two sub-pixels are turned on in the second sub-frame, and the center sub-pixel is turned on in the third sub-frame. In the third pattern, the center sub-pixel is turned on in the first sub-frame, all of the three sub-pixels are turned on in the second sub-frame, and the upper and lower two sub-pixels are turned on in the third sub-frame. In the fourth pattern, the upper and lower two sub-pixels are turned on in the first sub-frame, the center sub-pixel is turned on in the second sub-frame, and all of the three sub-pixels are turned on in the third sub-frame.

In the first pattern at the gray scale level of 7/9, the center sub-pixels are turned off in the second and third sub-frames and the other seven sub-pixels are turned on. In the second pattern, the center sub-pixels are turned off in the first and third sub-frames and the other seven sub-pixels are turned on. In the third pattern, the center sub-pixels are turned off in the first and second sub-frames and the other seven sub-pixels are turned on.

In the first pattern at the gray scale level of 8/9, the center sub-pixel is turned off in the second sub-frame and the other eight sub-pixels are turned on. In the second pattern, the center sub-pixel is turned off in the first sub-frame and the other eight sub-pixels are turned on. In the third pattern, the center sub-pixel is turned off in the third sub-frame and the other eight sub-pixels are turned on.

At the gray scale level of 9/9, all of the three sub-pixels are turned on in all of the first sub-frame, the second sub-frame, and the third sub-frame.

As described above, in the case of working example 2 of area coverage modulation at the area ratio of 1:2, the number of sub-frames of three, FRC drive at the time ratio of 1:1:1, triple speed display with ten gray scale levels of the gray scale level of 0/9 at which all of the nine sub-pixels are turned off to the gray scale level of 9/9 at which all of the nine sub-pixels are turned on is obtained.

### Working Example 3

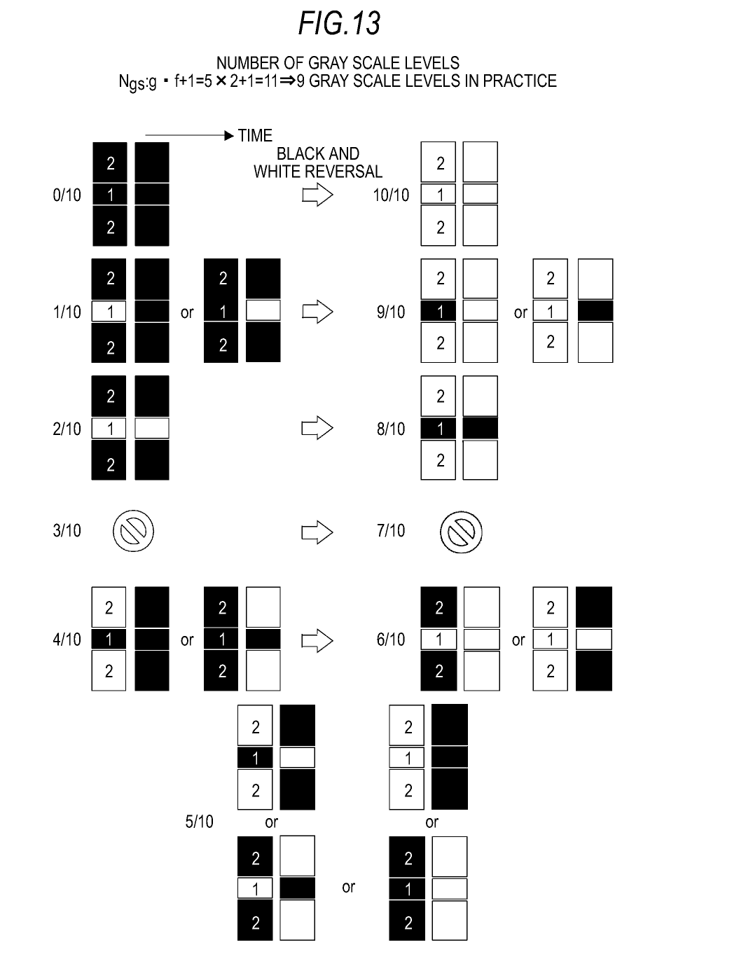

FIG. 13 is a diagram for explanation of combination patterns of sub-pixels in lighted states according to working example 3. Working example 3 is an example of area coverage modulation at the area ratio of 1:4, the number of sub-frames of two, FRC drive at the time ratio of 1:1.

Here, the area ratio of 1:4 is a ratio of the area of the center sub-pixel electrode to the total area of the upper and lower two sub-pixel electrodes assuming that the area of the center sub-pixel electrode is “1” and the respective areas of the upper and lower two sub-pixel electrodes are “2” in the three-split sub-pixel electrodes. In this case, g=5, f=2, and the number of display gray scale levels N_{gs} is N_{gs}=5×2+1=11, and double speed or faster display with eleven gray scale levels of 0/10 to 10/10 is obtained, however, in practice, double speed or faster display with nine-gray scale levels is obtained for reasons described later.

At the gray scale level of 0/10, all of the three sub-pixels are turned off in both the first sub-frame and the second sub-frame.

At the gray scale level of 1/10, the center sub-pixel is turned on in the first sub-frame and all of the three sub-pixels are turned off in the second sub-frame. At the gray scale level of 2/10, the center sub-pixels are turned on in both the first sub-frame and the second sub-frame.

In the case of the gray scale level of 3/10, it is assumed that the upper and lower two sub-pixels are simultaneously driven, and there is no combination of sub-pixels in the lighted states representing the gray scale level of 3/10. Therefore, the gray scale levels are discontinuous between the gray scale level of 2/10 and the gray scale level of 4/10. The same thing as that of the gray scale level of 3/10 applies the case of the gray scale level of 7/10.

At the gray scale level of 4/10, the upper and lower two sub-pixels are turned on in the first sub-frame and all of the three sub-pixels are turned off in the second sub-frame.

At the gray scale level of 5/10, there are two patterns such that the upper and lower two sub-pixels are turned on in the first sub-frame and the center sub-pixel is turned on in the second sub-frame or all of the three sub-pixels are turned on in the first sub-frame and all of the three sub-pixels are turned off in the second sub-frame. Note that, in the case of the right pattern in the drawing, the brightness difference (gray scale level difference) is larger between the first sub-frame and the second sub-frame, and flicker is likely to occur. Therefore, in the case of the gray scale level of 5/10, the better display condition is obtained in the left pattern in the drawing of the two patterns.

The gray scale levels of 6/10, 8/10, 9/10, 10/10 have interpolation relations with the gray scale levels of 4/10, 2/10, 1/10, 0/10, respectively.

At the gray scale level of 6/10, the center sub-pixel is turned on in the first sub-frame and all of the three sub-pixels are turned on in the second sub-frame.

At the gray scale level of 8/10, the upper and lower two sub-pixels are turned on in both the first sub-frame and the second sub-frame.

At the gray scale level of 9/10, the upper and lower two sub-pixels are turned on in the first sub-frame and all of the three sub-pixels are turned on in the second sub-frame. At the gray scale level of 10/10, all of the three sub-pixels are turned on in both the first sub-frame and the second sub-frame.

As described above, in the case of working example 3 of area coverage modulation at the area ratio of 1:4, the number of sub-frames of two, FRC drive at the time ratio of 1:1, double speed or faster display with nine gray scale levels is obtained because the gray scale levels of 3/10, 7/10 are excluded on the assumption that the upper and lower two sub-pixels are simultaneously driven. Note that, if the simultaneous drive of the upper and lower two sub-pixels is not assumed, that is, the upper and lower two sub-pixels are driven by separate driver circuits, display at the total eleven gray scale levels including the gray scale levels of 3/10, 7/10 may be realized.

Further, as in the case of the gray scale level of 5/10, in setting of the FRC patterns (patterns of sub-frames), by setting the patterns with the smaller brightness differences (gray scale differences) between the sub-frames, occurrence of flicker may be suppressed, and the better display condition may be obtained.

### Working Example 4

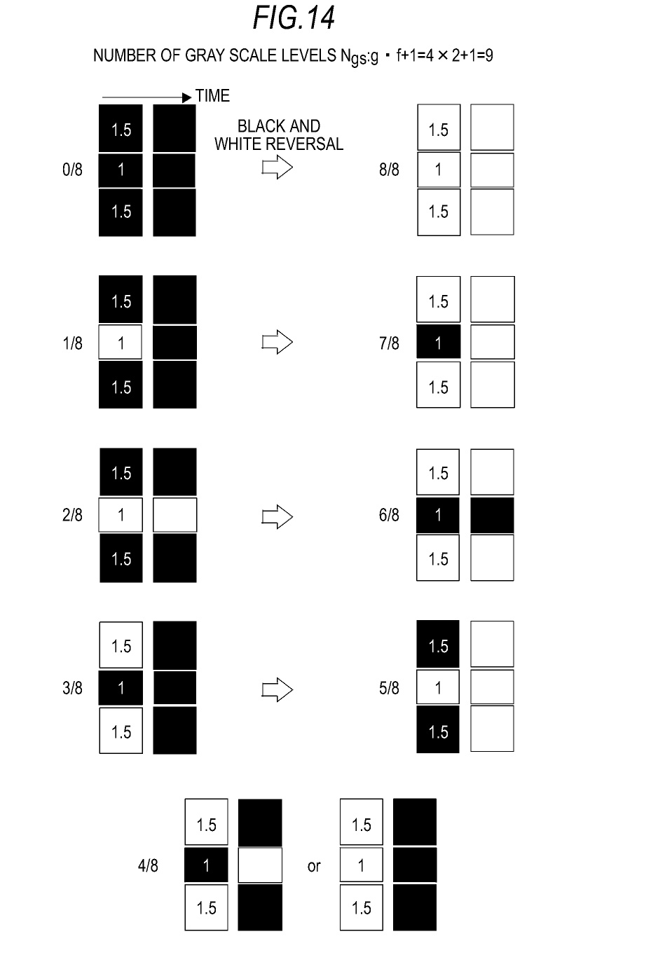

FIG. 14 is a diagram for explanation of combination patterns of sub-pixels in lighted states according to working example 4. Working example 4 is an example of area coverage modulation at the area ratio of 1:3, the number of sub-frames of two, FRC drive at the time ratio of 1:1.

Here, the area ratio of 1:3 is a ratio of the area of the center sub-pixel electrode to the total area of the upper and lower two sub-pixel electrodes assuming that the area of the center sub-pixel electrode is “1” and the respective areas of the upper and lower two sub-pixel electrodes are “1.5” in the three-split sub-pixel electrodes. In this case, g=4, f=2, and the number of display gray scale levels N_{gs} is N_{gs}=4×2+1=9, and double speed display with eight gray scale levels of 0/8 to 8/8 is obtained.

At the gray scale level of 0/8, all of the three sub-pixels are turned off in both the first sub-frame and the second sub-frame.

At the gray scale level of 1/8, the center sub-pixel is turned on in the first sub-frame and all of the three sub-pixels are turned off in the second sub-frame.

At the gray scale level of 2/8, the center sub-pixels are turned on in both the first sub-frame and the second sub-frame.

At the gray scale level of 3/8, the upper and lower two sub-pixels are turned on in the first sub-frame and all of the three sub-pixels are turned off in the second sub-frame.

At the gray scale level of 4/8, there are two patterns such that the upper and lower two sub-pixels are turned on in the first sub-frame and the center sub-pixel is turned on in the second sub-frame or all of the three sub-pixels are turned on in the first sub-frame and all of the three sub-pixels are turned off in the second sub-frame. Note that, in the case of the right pattern in the drawing, the brightness difference (gray scale level difference) is larger between the first sub-frame and the second sub-frame, and flicker is likely to occur. Therefore, in the case of the gray scale level of 4/8, the better display condition is obtained in the left pattern in the drawing of the two patterns.

The gray scale levels of 5/8, 6/8, 7/8, 8/8 have interpolation relations with the gray scale levels of 3/8, 2/8, 1/8, 0/8, respectively. That is, at the gray scale level of 5/8, the center sub-pixel is turned on in the first sub-frame and all of the three sub-pixels are turned on in the second sub-frame. At the gray scale level of 6/8, the upper and lower two sub-pixels are turned on in both the first sub-frame and the second sub-frame. At the gray scale level of 7/8, the upper and lower two sub-pixels are turned on in the first sub-frame and all of the three sub-pixels are turned on in the second sub-frame. At the gray scale level of 8/8, all of the three sub-pixels are turned on in both the first sub-frame and the second sub-frame.

As described above, in the case of working example 4 of area coverage modulation at the area ratio of 1:3, the number of sub-frames of two, FRC drive at the time ratio of 1:1, like the case of working example 3, double speed or faster display with nine gray scale levels is obtained. Note that, unlike the case of working example 3, the gray scale levels are continuous from the gray scale level of 0/8 to the gray scale level of 8/8. Therefore, the continuity of gray scale levels and display performance of the screen are more advantageous than those in the case of working example 3.

Further, as in the case of the gray scale level of 4/8, in setting of the FRC patterns (patterns of sub-frames), by setting the patterns with the smaller brightness differences (gray scale differences) between the sub-frames, occurrence of flicker may be suppressed, and the better display condition may be obtained.

Furthermore, it is preferable for working example 1 to working example 4 in common that the combination patterns of the sub-pixels in the lighted states in the respective plural sub-frames, i.e., the FRC patterns are changed between adjacent pixels. By changing the FRC patterns between adjacent pixels, occurrence of flicker may be suppressed compared to the case without change. As a method of changing the FRC patterns between adjacent pixels, methods of reversal of FRC patterns, sequential shift, phase shift, or the like may be exemplified.

Note that, in working example 1 to working example 4, it is assumed that the upper and lower two sub-pixel electrodes sandwiching the center sub-pixel electrode are simultaneously driven by one driver circuit. Accordingly, as described above, the number of pixels lighted at the same time are connected within the sub-frames, and the number of FRC patterns for coincidence of the centers of the pixels of gray scale representation with the centers of the display images among plural sub-frames is limited.

On the other hand, not limited to the configuration of simultaneous drive of the upper and lower two sub-pixels, but a configuration in which the three sub-pixels are independently driven by separate driver circuits may be employed. According to the configuration, not only the lighting patterns of the upper and lower two sub-pixels but also the lighting pattern of the combination of the center sub-pixel and the upper sub-pixel or the combination of the center sub-pixel and the lower sub-pixel may be realized, and the total FRC patterns may be significantly increased.

In the case where the configuration is employed, it may be impossible to bring the center of the pixel of gray scale representation into strict coincidence with the centers of the display image among plural sub-frames, however, by time integration among plural sub-frames, it may be possible to bring the center of the pixel of gray scale representation into substantial coincidence with the centers of the display images among plural sub-frames. This case may be included in the concept of “coincidence of the center of the pixel of gray scale representation with the centers of the display images among plural sub-frames”.

As above, the cases of the time ratio of 1:1 or 1:1:1, i.e., FRC drive without weighting of sub-frame times among plural sub-frames have been explained as examples. In the moving image display in the partial screen of the FRC drive without weighting of sub-frame times, it is assumed that there is the following relation with the number of all display gray scale levels N_{gs}, given that the full-screen display period of one frame is Tₒ, the number of display gray scale levels within the unit sub-frame is 2ⁿ, and the sub-frame period of partial display is T_{sf}. That is, given that the number of all display gray scale levels is N_{gs},

N_{gs}<2ⁿ×(Tₒ/T_{sf}).

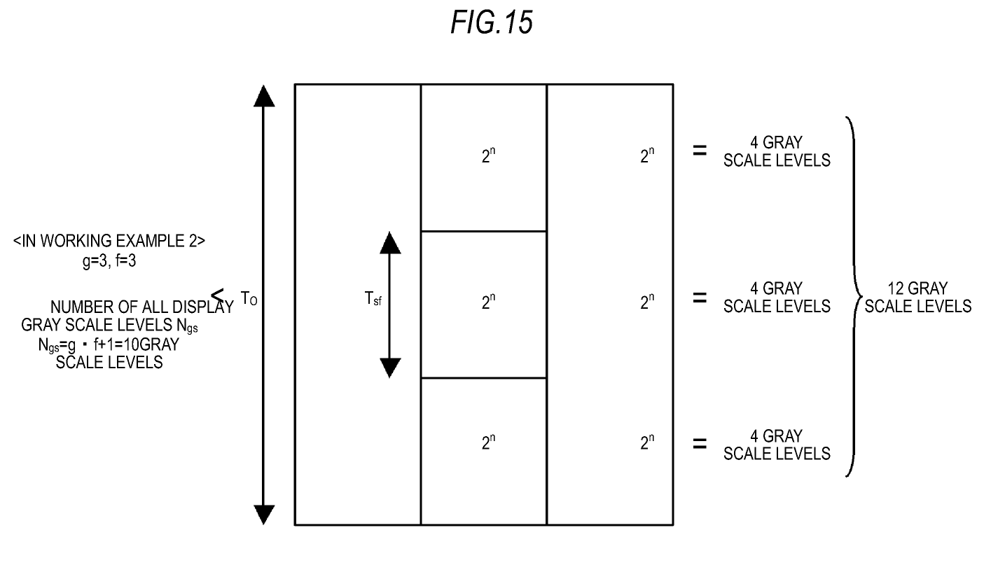

FIG. 15 shows a relation among the full-screen display period of one frame Tₒ, the number of display gray scale levels within the unit sub-frame 2ⁿ, the sub-frame period of partial display T_{sf}, and the number of all display gray scale levels N_{gs} by taking working example 2 as an example. In the case of working example 2, g=3, f=3 and N_{gs}=3×3+1=10, and the number of all display gray scale levels N_{gs} is ten. 2ⁿ=4, Tₒ/T_{sf}≧3, and thus, the right side is 12 or more.

(FRC Drive with Weighting of Sub-Frame Times)

Further, in working example 1 to working example 4, the cases of the FRC drive without weighting of the sub-frame times among the plural sub-frames have been explained as examples, however, the examples may be similarly applied to FRC drive with weighting of sub-frame times among the plural sub-frames. In typical gray scale representation of FRC drive with weighting of sub-frame times, given that the number of display gray scale levels within a unit sub-frame is 2ⁿ and the number of gray scale levels (number of sub-frames) according to the sub-frame period is 2^{m}, the number of display gray scale levels N_{gs} is N_{gs}=(2ⁿ)^{m}.

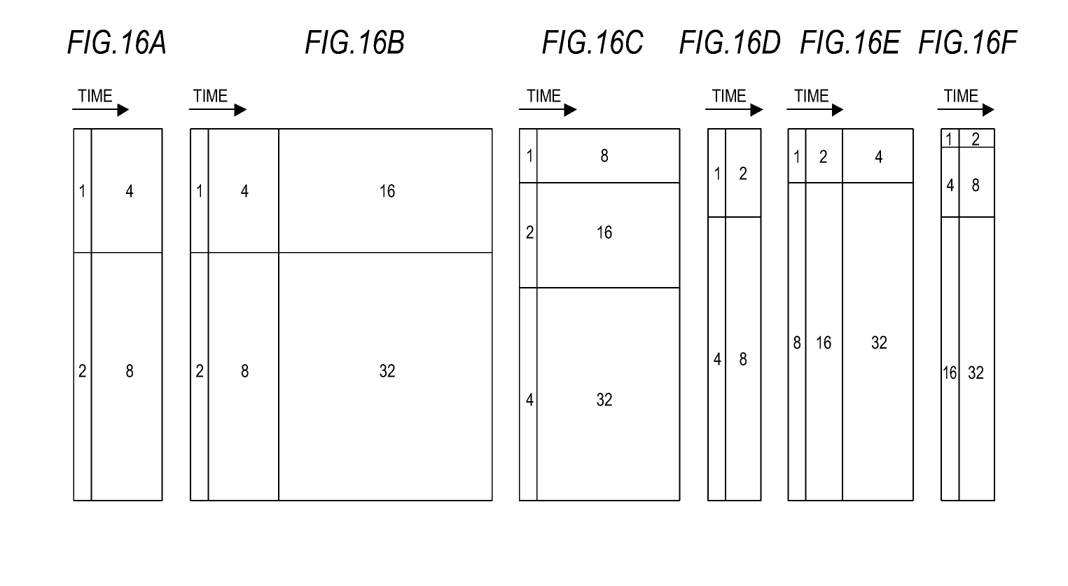

FIGS. 16A to 16F show specific examples of weighting with respect to sub-frame periods. FIG. 16A shows an example, in FRC drive in which one frame includes two sub-frames, at the ratio of first sub-frame time:second sub-frame time set to 1:4 and the area ratio set to 1:2.

FIG. 16B shows an example, in FRC drive in which one frame includes three sub-frames, at the ratio of first sub-frame time:second sub-frame time:third sub-frame time set to 1:4:16 and the area ratio set to 1:2.

FIG. 16C shows an example, in FRC drive in which one frame includes two sub-frames, at the ratio of first sub-frame time:second sub-frame time set to 1:8 and the area ratio set to 1:2:4. FIG. 16D shows an example, in FRC drive in which one frame includes two sub-frames, at the ratio of first sub-frame time:second sub-frame time set to 1:2 and the area ratio set to 1:4.

FIG. 16E shows an example, in FRC drive in which one frame includes three sub-frames, at the ratio of first sub-frame time:second sub-frame time:third sub-frame time set to 1:2:4 and the area ratio set to 1:8. FIG. 16F shows an example, in FRC drive in which one frame includes two sub-frames, at the ratio of first sub-frame time:second sub-frame time set to 1:2 and the area ratio set to 1:4:16.

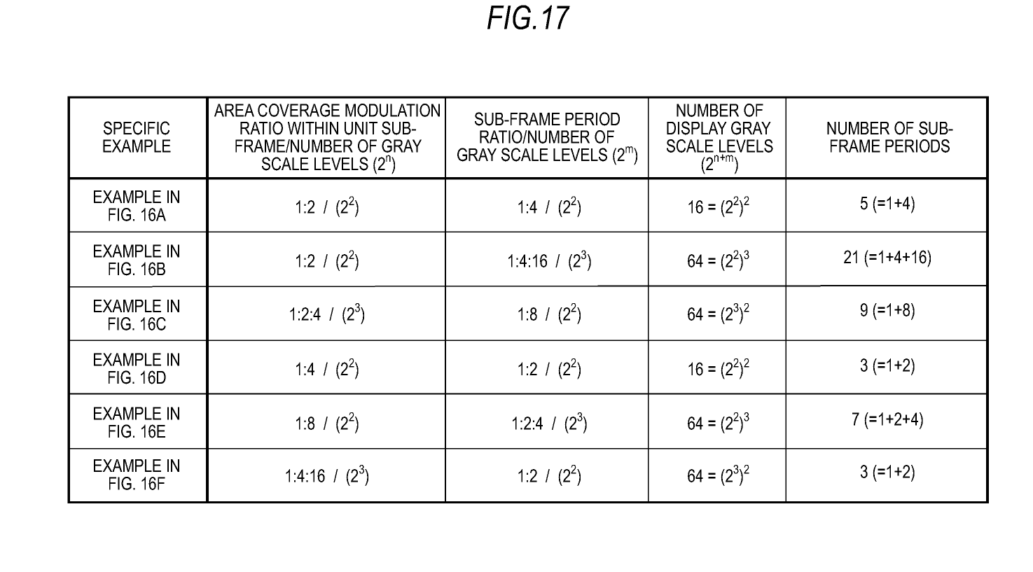

As described above, higher gray scale representation may be performed by combinations of the number of display gray scale levels within the unit sub-frame 2ⁿ and the number of sub-frames 2^{m}. The number of display gray scale levels 2^{(n+m)} in the respective specific examples of weighting with respect to sub-frame times shown in FIGS. 16A to 16F are shown in FIG. 17.

That is, in the case of the specific example in FIG. 16A, the area coverage modulation ratio within unit sub-frame/number of gray scale levels (2ⁿ) is 1:2/(2²), the sub-frame period ratio (time ratio)/number of gray scale levels (2^{m}) is 1:4/(2²), the number of display gray scale levels (2^{n+m)} is 16 (=(2²)²), and the number of sub-frame periods is 5 (=1+4). In the case of the specific example in FIG. 16B, the area coverage modulation ratio within unit sub-frame/number of gray scale levels (2ⁿ) is 1:2/(2²), the sub-frame period ratio/number of gray scale levels (2^{m}) is 1:4:16/(2³), the number of display gray scale levels (2^{n+m}) is 64 (=(2²)³), and the number of sub-frame periods is 21 (=1+4+16).

In the case of the specific example in FIG. 16C, the area coverage modulation ratio within unit sub-frame/number of gray scale levels (2ⁿ) is 1:2:4/(2³), the sub-frame period ratio/number of gray scale levels (2^{m}) is 1:8/(2²), the number of display gray scale levels (2^{n+m}) is 64 (=(2³)²), and the number of sub-frame periods is 9 (=1+8). In the case of the specific example in FIG. 16D, the area coverage modulation ratio within unit sub-frame/number of gray scale levels (2ⁿ) is 1:4/(2²), the sub-frame period ratio/number of gray scale levels (2^{m}) is 1:2/(2²), the number of display gray scale levels (2^{n+m}) is 16 (=(2²)²), and the number of sub-frame periods is 3 (=1+2).

In the case of the specific example in FIG. 16E, the area coverage modulation ratio within unit sub-frame/number of gray scale levels (2ⁿ) is 1:8/(2²), the sub-frame period ratio/number of gray scale levels (2^{m}) is 1:2:4/(2³), the number of display gray scale levels (2^{n+m}) is 64 (=(2²)³), and the number of sub-frame periods is 7 (=1+2+4). In the case of the specific example in FIG. 16F, the area coverage modulation ratio within unit sub-frame/number of gray scale levels (2ⁿ) is 1:4:16/(2³), the sub-frame period ratio/number of gray scale levels (2^{m}) is 1:2/(2²), the number of display gray scale levels (2^{n+m}) is 64 (=(2³)²), and the number of sub-frame periods is 3 (=1+2).

### <3. Electronic Apparatus>

The above described display device according to the embodiment of the present disclosure may be used as display units (display devices) of an electronic apparatus in every field of displaying video signals input to the electronic apparatus or video signals generated within the electronic apparatus as images or videos.

As is clear from the above described explanation of the embodiment, the display device according to the embodiment of the present disclosure may further increase the number of display gray scale levels and further improve the display characteristics because no fluctuation is produced in display images. Therefore, in an electronic apparatus of every field, images with the higher image quality may be displayed using the display device according to the embodiment of the present disclosure as the display unit thereof.

As an electronic apparatus using the display device according to the embodiment of the present disclosure as the display unit thereof, for example, a digital camera, a video camera, a PDA (Personal Digital Assistant), a game machine, a notebook personal computer, a portable information device such as an electronic book, a mobile communications device such as a cellular phone may be exemplified.

### <4. Configuration of Embodiment of the Present Disclosure>

The present disclosure may be implemented as the following configurations.

(1) A display device having a memory function within pixels, including a drive unit that divides image generation for one frame into plural sub-frames and performs display drive by time-division drive in units of sub-frames,

wherein the drive unit performs drive of bringing centers of pixels of gray scale representation into coincidence with centers of display images among the plural sub-frames.

(2) The display device according to (1), wherein, in the case of partial moving image display of partially displaying moving images near a center part of a display screen, there are relations among a full-screen display period of one frame, a sub-frame period of partial display, the number of sub-frames of time-division drive, and a limit period of flicker in human vision such that the full-screen display period of one frame is smaller than the limit period of flicker in human vision and a total sub-frame period determined by the sub-frame period of partial display and the number of sub-frames of time-division drive is smaller than the full-screen display period.

(3) The display device according to (2), wherein the limit period is 1/50 Hz or 1/60 Hz.

(4) The display device according to any one of (1) to (3), further including a subtractive color processing unit that performs subtractive color processing on input data and provides the data to the drive unit.

(5) The display device according to (4), wherein the subtractive color processing unit performs subtractive color processing using an error diffusion method or a dither method.

(6) The display device according to (4) or (5), wherein the drive unit converts the data subjected to subtractive color processing in the subtractive color processing unit into data with the smaller number of bits than that of the data.

(7) The display device according to any one of (1) to (6), wherein the pixel has a memory part that stores data.

(8) The display device according to any one of (1) to (6), wherein memory liquid crystal is used for the pixel.

(9) The display device according to any one of (1) to (8), wherein the pixel includes plural sub-pixels and displays gray scale levels by combinations of areas of the plural sub-pixels.

(10) The display device according to (9), wherein a pixel electrode of the pixel is divided into plural electrodes with respect to each of the plural sub-pixels, and performs gray scale representation by combinations of areas of the plural electrodes.

(11) The display device according to (10), wherein the plural electrodes include three electrodes and perform gray scale representation by combinations of a center electrode and two electrodes sandwiching the center electrode.

(12) The display device according to (11), wherein the two electrodes have the same area.

(13) The display device according to (11) or (12), wherein the two electrodes are electrically connected to each other and driven by one driver circuit.

(14) The display device according to (13), wherein, in setting of combination patterns of the sub-pixels in lighted states in each of the plural sub-frames, the patterns with the smaller brightness differences between the sub-frames are set.

(15) The display device according to (13), wherein combination patterns of the sub-pixels in lighted states in each of the plural sub-frames are changed between the adjacent pixels.

(16) The display device according to any one of (1) to (15), wherein the drive unit performs time-division drive without weighting of sub-frame times among plural sub-frames.

(17) The display device according to (16), wherein, in moving image display of partial screen of the time-division drive without weighting of sub-frame times among plural sub-frames, the number of all display gray scale levels is smaller than (the number of display gray scale levels within a unit sub-frame)×(the full-screen display period of one frame/a display period of partial display screen).

(18) The display device according to any one of (1) to (17), wherein the drive unit performs the time-division drive with weighting of sub-frame times among the plural sub-frames.

(19) A driving method of a display device, in driving of the display device having a memory function within pixels, including:

dividing image generation for one frame into plural sub-frames and performing display by time-division drive in units of sub-frames; and

bringing centers of pixels of gray scale representation into coincidence with centers of display images among the plural sub-frames.

(20) An electronic apparatus having a display device with a memory function within pixels, including a drive unit that divides image generation for one frame into plural sub-frames and performs display by time-division drive in units of sub-frames,

wherein the drive unit performs drive of bringing centers of pixels of gray scale representation into coincidence with centers of display images among the plural sub-frames.

The present disclosure contains subject matter related to that disclosed in Japanese Priority Patent Application JP 2011-196903 filed in the Japan Patent Office on Sep. 9, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A display device having a memory function within pixels, comprising:
a drive unit that divides image generation for one frame into plural sub-frames and performs display drive by time-division drive in units of sub-frames,
wherein the drive unit performs drive of bringing centers of pixels of gray scale representation into coincidence with centers of display images among the plural sub-frames.

2. The display device according to claim 1, wherein, in the case of partial moving image display of partially displaying moving images near a center part of a display screen, there are relations among a full-screen display period of one frame, a sub-frame period of partial display, the number of sub-frames of time-division drive, and a limit period of flicker in human vision such that the full-screen display period of one frame is smaller than the limit period of flicker in human vision and a total sub-frame period determined by the sub-frame period of partial display and the number of sub-frames of time-division drive is smaller than the full-screen display period.

3. The display device according to claim 2, wherein the limit period is 1/50 Hz or 1/60 Hz.

4. The display device according to claim 1, further comprising a subtractive color processing unit that performs subtractive color processing on input data and provides the data to the drive unit.

5. The display device according to claim 4, wherein the subtractive color processing unit performs subtractive color processing using an error diffusion method or a dither method.

6. The display device according to claim 4, wherein the drive unit converts the data subjected to subtractive color processing in the subtractive color processing unit into data with the smaller number of bits than that of the data.

7. The display device according to claim 1, wherein the pixel has a memory part that stores data.

8. The display device according to claim 1, wherein memory liquid crystal is used for the pixel.

9. The display device according to claim 1, wherein the pixel includes plural sub-pixels and displays gray scale levels by combinations of areas of the plural sub-pixels.

10. The display device according to claim 9, wherein a pixel electrode of the pixel is divided into plural electrodes with respect to each of the plural sub-pixels, and performs gray scale representation by combinations of areas of the plural electrodes.

11. The display device according to claim 10, wherein the plural electrodes include three electrodes and perform gray scale representation by combinations of a center electrode and two electrodes sandwiching the center electrode.

12. The display device according to claim 11, wherein the two electrodes have the same area.

13. The display device according to claim 11, wherein the two electrodes are electrically connected to each other and driven by one driver circuit.

14. The display device according to claim 13, wherein, in setting of combination patterns of the sub-pixels in lighted states in each of the plural sub-frames, the patterns with the smaller brightness differences between the sub-frames are set.

15. The display device according to claim 13, wherein combination patterns of the sub-pixels in lighted states in each of the plural sub-frames are changed between the adjacent pixels.

16. The display device according to claim 1, wherein the drive unit performs time-division drive without weighting of sub-frame times among plural sub-frames.

17. The display device according to claim 16, wherein, in moving image display of partial screen of the time-division drive without weighting of sub-frame times among plural sub-frames, the number of all display gray scale levels is smaller than (the number of display gray scale levels within a unit sub-frame)×(the full-screen display period of one frame/a display period of partial display screen).

18. The display device according to claim 1, wherein the drive unit performs the time-division drive with weighting of sub-frame times among the plural sub-frames.

19. A driving method of a display device, in driving of the display device having a memory function within pixels, comprising:
dividing image generation for one frame into plural sub-frames and performing display by time-division drive in units of sub-frames; and
bringing centers of pixels of gray scale representation into coincidence with centers of display images among the plural sub-frames.

20. An electronic apparatus comprising:
a display device with a memory function within pixels, and including a drive unit that divides image generation for one frame into plural sub-frames and performs display by time-division drive in units of sub-frames,
wherein the drive unit performs drive of bringing centers of pixels of gray scale representation into coincidence with centers of display images among the plural sub-frames.
